(19) United States
(12) Patent Application Publication
(10) Pub. No.: US 2013/0301661 A1
(43) Pub. Date: Nov. 14, 2013

(54) Optical Signal Processing

(71) Applicants: Joseph Kakande, Southampton (GB); Francesca Parmigiani, Southampton (GB); Periklis Petropoulos, Southampton (GB); David John Richardson, Southampton (GB); Radan Slavik, Southampton (GB)

(72) Inventors: Joseph Kakande, Southampton (GB); Francesca Parmigiani, Southampton (GB); Periklis Petropoulos, Southampton (GB); David John Richardson, Southampton (GB); Radan Slavik, Southampton (GB)

(21) Appl. No.: 13/825,618

(22) PCT Filed: Sep. 16, 2011
(86) PCT No.: PCT/GB11/01356

§ 371 Date: Jun. 19, 2013

(30) Foreign Application Priority Data
Sep. 22, 2010 (GB) 1015909.3

(51) Int. Cl. H04B 10/61

(52) U.S. Cl. CPC H04B 10/616
USPC 370/536

(57) ABSTRACT

An optical device, suitable for use either as a coherent receiver or analog-to-digital converter, of optical phase modulated signals borne on a carrier. The signal is four-wave mixed with a pump to generate a non-linear comb of a series of harmonic components of the signal. The modulation-free carrier is also combined with the pump to generate an equivalent linear comb matched in frequency to the components of the non-linear comb. The harmonic and modulation-free components are linearly combined so they interfere in a pairwise manner, and then the interfered frequency components are separated out in an optical wavelength division demultiplexer into a plurality of frequency-specific optical output channels. A plurality of photodetectors connected to respective ones of the optical output channels then converts the analog values in each channel to respective electronic signals which are then digitized using a processor into binary digits using a thresholding process.

### BACKGROUND OF THE INVENTION

The invention relates to optical signal processing, and in particular to devices for opto-electronically converting multi-level phase-encoded data signals and for opto-electronically converting analog phase-encoded optical signals into electronic digitized signals.

The future of optical fiber communications will be dictated by the need for long reach, high capacity and energy efficient technologies. Transitioning to spectrally efficient modulation formats such as quadrature phase shift keying (QPSK) provides significant capacity gains in long haul optical links. Fully coherent optical signal detection combined with high speed analog-to-digital conversion allows signal processing in the electronic domain, providing capabilities such as compensation for chromatic and polarization mode dispersion, as well as for some of the accumulated nonlinear phase noise which is the dominant limitation in extending coherent transmission spans (see, for example, E. Ip et. al., Opt. Express 16, 753-791; 2008).

However, the power consumption as well as the significant computing overhead associated with the aforementioned electronic functions means (see, for example, K. Roberts et. al., J. Lightwave Technol. 27, 3546-3559; 2009) that a combination of optical signal processing with optical dispersion compensation may still prove competitive for long haul transmission, particularly as signalling rates continue to rise.

Maximising spectral efficiency in communications networks is a major goal being pursued by academic research labs, telecoms component manufacturers, systems vendors, and network operators worldwide. The current industry consensus is to utilise multi-level signal formats, in which each transmitted symbol carries more than one bit of information, achieved by having multiple possible levels in phase or/and amplitude.

FIG. 1 is a block diagram showing a standard approach for opto-electronically converting multi-level phase-encoded signals, such as QPSK signals (see, for example, J. C. Rasmussen et al Fujitsu Sci Tech J, 46, 63-71; 2010). The incoming QPSK signal from the long-haul fiber network is mixed in an optical hybrid 2 with a local oscillator (LO) 3 which is modulation-free. The optical hybrid 2 serves to separate out the quadrature states into respective outputs 4 which are then opto-electronically converted in pairs by balanced photodetectors 5a, 5b. The electronic signals from the photodetector pairs 5a, 5b are then amplified by suitable amplifiers 6a, 6b, filtered by low pass filters (LPF) 7a, 7b and digitized by analog-to-digital converters (ADCs) 8a, 8b. A digital signal processor (DSP), field programmable gate array (FPGA) or other microprocessor 9 is then used to decode the signal by phase recovery and output the originally multi-level optical signal decoded into an electronic binary data stream from output 10. The device is thus split between an optical front-end and an electronic back-end.

The technological challenge is how to carry out the decoding of optical multi-level phase encoded signals into a binary electronic bit stream at ever faster bit rates in real time, with the current limit being around the 10-25 Gbaud range. In addition to being limited in terms of speed, the majority of the decoding algorithms are computationally intensive and therefore are associated with fairly high power usage of several Watts per channel.

An area that is related to decoding multi-level phase encoded optical signals is optical analog-to-digital conversion (ADC). This is because an analog signal may be regarded as an infinite level signal, so that a device capable of decoding multi-level phase encoded optical signals of arbitrary level should in principle also be capable of decoding analog signal encoded in phase, and also amplitude modulated analog signals which have been converted into phase modulated signals in a pre-processing stage.

Photonic ADCs are appealing due to their ability to allow orders of magnitude higher operating speeds (>100 Gsamples/s) with exponentially lower timing jitter than electronic ADCs. Photonic systems, with their large bandwidths and low-noise operation, have the potential to be directly substituted for their electronic counterparts, improving the integrated system and extending the overall performance.

Photonic ADCs began as a simple parallel electro-optical structure in 1975 and evolved through the use of mode-locked lasers. Utilizing the precise sampling provided by mode-locked lasers, several varieties of photonic ADCs were invented, but all employ electronic ADCs as thefinal conversion stage. A cascaded phase modulation system for high -speed photonic ADCs has recently been utilizing distributed phase modulation to quantize the signals in the optical domain; thus, the output is in a form similar to a nonreturn-to-zero (NRZ) optical data pattern. This type of optical processing was first discussed by Taylor (1979) who used parallel Mach-Zehnder interferometers for this task.

### SUMMARY OF THE INVENTION

The invention provides a device design, suitable for use either as a coherent receiver or analog-to-digital converter, for processing an optical phase modulated signal borne on a carrier, the device comprising: a pump source operable to generate a first modulation-free pump having a frequency offset from the carrier; an optical non-linear comb generator comprising a section of non-linear optical material arranged to receive the signal and the pump, in which the pump and the signal are subject to four-wave mixing to generate a non-linear comb of a series of harmonic components of the signal separated in frequency by the offset; an optical linear comb generator arranged to receiver the carrier and to generate therefrom linear comb of a series of modulation-free components matched in frequency to the harmonic components generated by the non-linear comb generator; an optical combiner connected to receive and linearly combine a selection of at least one of, preferably a plurality of, the harmonic series components and their corresponding frequency-matched modulation-free component or components; an optical wavelength division demultiplexer connected to receive and separate out the linearly combined pairs of harmonic and modulation-free components into a plurality of frequency-specific optical output channels; and a plurality of photodetectors connected to respective ones of the optical output channels, each photodetector being operable to output an electronic signal representing the intensity of the received linearly combined component pair.

The linear comb generator in some embodiments comprises an optical phase modulator arranged to receive the carrier, free of phase modulation, and having a drive input to receive an electronic clock signal that acts to phase modulate the carrier in order to generate the linear comb. The linear comb generator in other embodiments comprises non-linear optical material and is connected to receive the carrier, free of phase modulation, and the first pump, in which the pump and the modulation-free carrier are subject to four-wave mixing to generate the linear comb. A non-exhaustive list of other options is: active optical devices such as mode locked lasers, optical micro-resonators, semiconductor optical amplifiers, electro-absorptive modulators etc.

The opto-electronic device may be used in combination with an electronic signal processor having a threshold detector operable to receive the electronic signals from the photodetectors and translate each electronic signal into a binary output based on a threshold decision.

In some embodiments, both for coherent receiver and ADC versions, the harmonic series of components selected for linear combination and photodetection consists of a plurality of adjacent elements the series 2ⁿ, such as the 1st, 2nd and 4th components or 1st, 2nd, 4th and 8th components. Alternatively, in other embodiments, the harmonic series of components selected for linear combination and photodetection consists of the 1st, 2nd and 3rd components which has been suggested as being highly power efficient for data transmission.

To generate higher order harmonic components a non-linear comb generator can be provided in which one of the harmonic components generated by four-wave mixing in the non-linear optical material is picked out and four-wave mixed with a further pump, in a second four-wave mixing stage. The further pump has a frequency separation from the picked out component equal to said frequency offset or an integer fraction or multiple thereof so as to generate further harmonic components that conform to the comb frequencies and have greater power than equivalent harmonic components at the same frequency generated by the initial four-wave mixing. The non-linear comb generator may further comprise third and optionally further four-wave mixing stages, each arranged to mix a further pump with a harmonic component picked out from a prior four-wave mixing stage so as to further supplement the comb with higher order components of useable power.

It is possible to handle amplitude modulated signals by providing a signal pre-processing stage arranged to receive an optical amplitude modulated signal and convert it to an optical phase modulated signal.

It is also possible to handle mixed amplitude and phase modulated signals by providing a splitter arranged to receive an optical phase and amplitude modulated signal and separate it into two parts, one of which is supplied as input to one of the above-described devices, and the other of which is supplied via a signal pre-processing stage operable to convert the amplitude modulated part of the signal into a phase modulated signal to a further device of the above-described type.

In coherent receiver implementations, the phase modulated signal is a multi-level phase modulated signal containing encoded binary data. In ADC implementations, the phase modulated signal is an analog phase modulated signal representing a scalar parameter.

The invention therefore also includes a method of decoding an optical multi-level phase modulated signal containing encoded binary data comprising supplying the phase modulated signal to a device of the above-described type, and to a method of decoding an optical analog phase modulated signal representing a scalar parameter comprising supplying the phase modulated signal to a device of the above-described type.

### BRIEF DESCRIPTION OF THE DRAWINGS

The invention is now described by way of example only with reference to the following drawings.

FIG. 1 is a block diagram showing a standard approach for opto-electronically converting multi-level phase-encoded signals.

FIG. 2 is a conceptual diagram showing frequency components relevant for a coherent optical receiver for decoding a 2-bit, i.e. 4-level, phase shift keyed (PSK) signal according to a first embodiment with FIG. 2(a) showing the frequency products of non-linear comb and FIG. 2(b) the frequency products of a linear comb.

FIG. 3 is a block diagram of a coherent optical receiver according to the first embodiment.

FIG. 4 shows a non-linear comb generator part of the first embodiment.

FIG. 5 shows one implementation of the linear optical comb generator part of the first embodiment.

FIG. 6 shows another implementation of the linear optical comb generator part of the first embodiment.

FIG. 7 is a graph showing the 2-bit analog-to-digital conversion scheme of the first embodiment which combines the first and second phase harmonics of the non-linear comb with the corresponding frequency components of the linear comb.

FIG. 8 is similar to FIG. 2 but shows shaded the frequency components relevant for a coherent optical receiver for decoding a 3-bit, i.e. 8-level, phase shift keyed (PSK) signal according to a variant of the first embodiment with FIG. 8(a) showing the frequency products of non-linear comb and FIG. 8(b) the frequency products of a linear comb.

FIG. 9 is a graph of the same type as FIG. 7 showing a 3-bit analog-to-digital conversion scheme of the variant of the first embodiment which combines the first, second and fourth phase harmonics of the non-linear comb with the corresponding frequency components of the linear comb.

FIG. 10 is a block diagram of an analog-to-digital converter (ADC) according to a second embodiment.

FIG. 11 shows a non-linear comb generator for generating arbitrary numbers of phase harmonics which is particularly suited for use as the non-linear comb generator in a higher bit number ADC according to the second embodiment.

FIG. 12 shows a pre-processing front end for converting an amplitude modulated signal into a phase modulated signal that can be input into the ADC of the second embodiment.

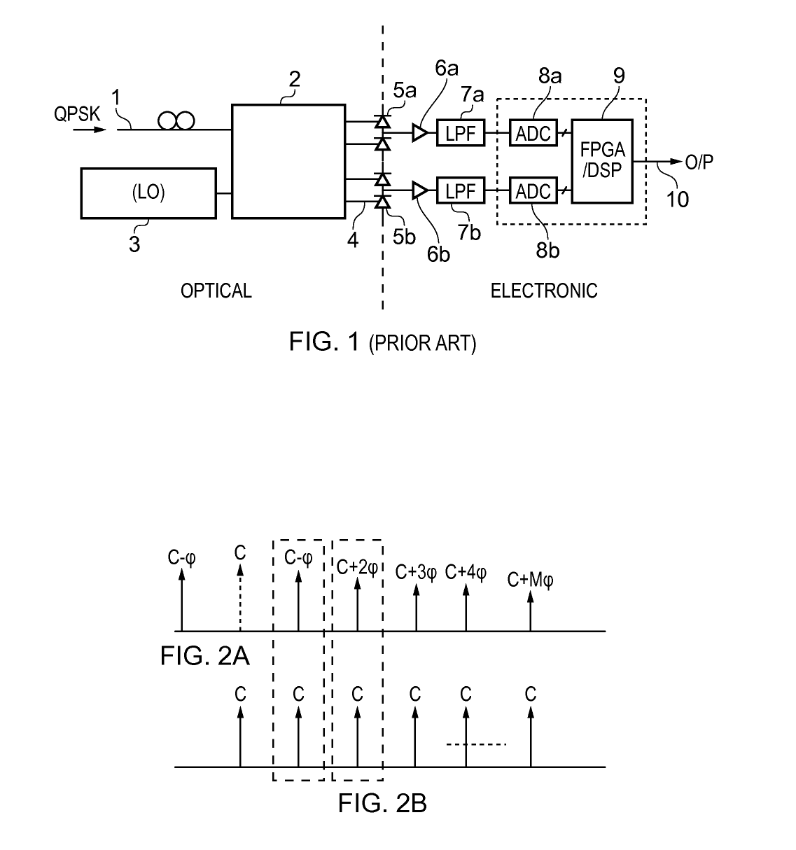

### DETAILED DESCRIPTION

FIG. 2 is a conceptual diagram showing frequency components relevant for a coherent optical receiver for decoding a 2-bit, i.e. 4-level, phase shift keyed (PSK) signal according to a first embodiment.

FIG. 2(a)—the upper part of the figure—shows a non-linear comb of made up of a sequence of signal components generated by four wave mixing (FWM) of a phase encoded signal of the wavelength of the (zeroth order) component labeled C with a pump signal having a frequency offset from the signal frequency. The signal components are separated equally in frequency or energy. Over a small wavelength span, it is also a good approximation to consider the signals to be equally separated in wavelength. Generally a signal with phase encoded data of phase cp can be converted by four wave mixing with a pump signal having a wavelength offset from the signal frequency to the series of components illustrated which can be mathematically expressed as the expansion:

m₁exp(i·φ)+m₂exp(i·2φ)+m₃exp(i·3φ)+m₄exp(i·4φ) . . . m_{M}exp(i·Mφ)

The components are in a ladder, staircase, or comb with each element separated by the offset, i.e. difference, between the pump and signal frequencies. The first harmonic component is labeled C+φ and the Mth harmonic component as C+Mφ. The series also extends to negative terms, with only the first order negative term C−φ being illustrated. Only the lower frequency (higher wavelength) components are exploited in the devices described below, but other devices falling within the scope of the invention may exploit these negative order components either on their own or in combination with positive order components.

FIG. 2(b)—the lower part of the figure—shows a linear comb with frequencies matched to that of the non-linear comb of FIG. 2(a), wherein these signals are different from the signals of the upper part of the figure in that they do not contain any phase encoded data, but are pure carrier replicas, generated by continuous wave (CW) laser sources driven to be synchronous and coherent with the carrier of the phase encoded signal.

The FWM comb components of FIG. 2(a) thus have signal mixed with the carrier, whereas the CW comb components of FIG. 2(b) are locked to the carrier and free of signal modulation.

Conceptually, the coherent optical receiver of the first embodiment is based on generating the comb of FIG. 2(a) and selecting through filtering two or more of the components. The selected non-linear comb components typically include the first order harmonic component C+φ and at least one other higher order harmonic component such as C+2φ. In the illustrated example, the shading indicates selection of the first and second order components. Moreover, as shown by the shading in FIG. 2(b), the coherent optical receiver of the first embodiment is based on selecting the carrier replicas at the frequencies matched to the selected non-linear comb components.

The relevant ones, i.e. the shaded ones in the illustrated example, of the harmonic series components and their corresponding frequency-matched modulation-free components are linearly combined in such a way that, at each of the combined comb frequencies, the light has an intensity that is proportional to the instantaneous phase condition of the harmonic component. This light intensity can then be converted into an analog electrical signal by a photodetector which can be electronically processed to apply a thresholding to generate a binary digit output. Such a device thus operates optoelectronically convert an optical multi-level phase encoded signal into a digitized electronic signal.

Since an analog signal may be viewed as an infinite level signal, the same device design may also be used as an analog-to-digital converter (ADC) to convert an optical analog phase signal into a digitized electronic signal.

By generating a FWM comb, as well as a linear comb locked to carrier, it is possible to build a fully coherent optical receiver, performing the operations carried out in an electronic ADC combined with a digital signal processor (DSP). Moreover, the all-optical implementation should in principle be capable of processing much higher data rates than is possible with electronic processing, and potentially with better power efficiency.

In the following, the coherent optical receiver implementation is described initially, and then the ADC implementation.

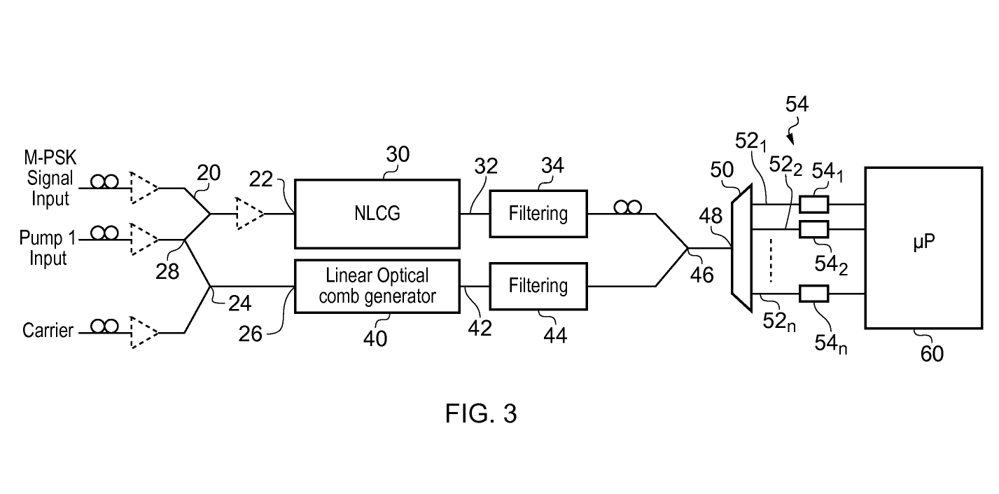

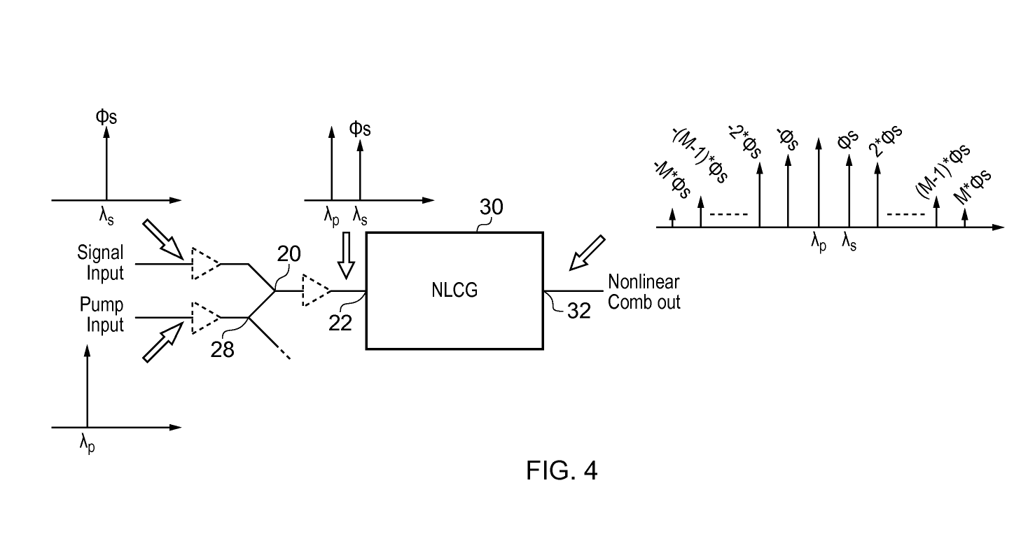

FIG. 3 is a block diagram of a coherent optical receiver according to the first embodiment and FIG. 4 shows a non-linear comb generator part of the first embodiment with associated optical signal components.

In the figures, optional amplification stages are shown in dotted lines using conventional triangle symbols. In fiber implementations these may be erbium doped fiber amplifiers (EDFAs). In semiconductor implementations these may be semiconductor optical amplifiers (SOAs). In other implementations these may be Raman or optical parametric amplifiers. Optical fiber polarization controllers are also illustrated using conventional double loop symbols. These standard components are not referred to in the following description. The figures assume an optical fiber implementation, with the lines between optical components being optical fibers, and the junctions between the lines being fiber couplers of suitable coupling ratio such as 50:50 or a different ratio as desired. It will be appreciated that other technologies could be used to implement the same device, such as lithium niobate waveguides, semiconductor waveguides, glass waveguides or free space optics with glass or other components.

The coherent receiver is supplied with an M-level optical phase modulated signal M-PSK carrying phase data φₛ borne on a carrier of wavelength λₛ. The coherent receiver is also supplied with a pump—Pump 1—at wavelength λₚ provided by a suitable pump source (not shown) which may be integrated with the coherent receiver or an external component. Pump 1 is free of the phase modulation of the signal and its wavelength λₚ is offset from the signal wavelength λₛ. The signal and pump are combined in a fiber coupler 20 and supplied to an input 22 of a non-linear comb generator (NLCG) 30 which is used to generate the non-linear comb illustrated in FIG. 2(a).

The NLCG comprises a section of non-linear optical material arranged to receive the signal and the pump, in which the pump and the signal are subject to four-wave mixing to generate a non-linear comb of a series of harmonic components of the signal φₛ, 2φₛ, 3φₛ, 4φₛ . . . Mφₛ separated in wavelength (actually frequency) by the offset |λₚ−λₛ. The non-linear optical material may be a third order nonlinear optical medium or cascaded second order nonlinear optical media to allow four wave mixing and thereby to generate the non-linear comb. The non-linear media for the NLCG can be chosen from a wide variety of known possibilities. In the example below, a silica highly nonlinear fiber is used. A non-exhaustive list of other options is: a silicon waveguide, liquid or gaseous nonlinear media, periodically poled lithium niobate (PPLN), a semiconductor waveguide, a chalcogenide waveguide. Microresonator, and nanowire nonlinear waveguide embodiments in crystalline and glass materials can also be envisaged.

The coherent receiver also receives as an input the modulation-free carrier wave. The modulation-free carrier wave may be supplied along the transmission line with the signal from the transmitter by tapping off a portion of the carrier at the transmitter before the carrier is phase modulated. Alternatively, the carrier wave may be recovered at the receiver from the signal by removing the phase modulation from a tapped off portion of the signal. A carrier recovery unit for performing this function could be integrated with the coherent receiver.

The carrier and a tapped off portion of the pump—Pump 1—tapped off from the pump path to the NLCG 30 by a coupler 28 are combined in a fiber coupler 24 and supplied to an input 26 of a linear comb generator (LCG) 40 which is used to generate the linear comb illustrated in FIG. 2(b). The linear comb is a series of modulation-free components matched in frequency to the harmonic components generated by the non-linear comb generator. The harmonic components output from the NLCG at its output 32 are subject to filtering in a filter 34, principally to cut off all but the frequency components intended for use in the subsequent decoding which are the first and second components in the illustrated example of FIG. 2(a). The carrier replica components output from the LCG at its output 42 are also subject to filtering in a filter 44, principally to cut off the same frequency components as just mentioned. However, it is noted this is optional, since in principle all carrier replica components could be maintained if the undesired harmonic components have been eliminated in the other arm of the device.

An optical combiner 46, such as a fiber coupler, is connected to receive and linearly combine at least selected ones of the harmonic series components and their corresponding frequency-matched modulation-free components. The output from the optical combiner is supplied to the input 48 of an optical wavelength division demultiplexer 50 which separates out the linearly combined pairs of harmonic and modulation-free components into a plurality of frequency-specific optical output channels. The output channels 52₁, 52₂, . . . 52ₙ are connected to respective photodetectors 54₁, 54₂, . . . 54ₙ of a photodetector bank 54. Each photodetector outputs an electronic signal representing the intensity of the received linearly combined component pair. A processor 60 is arranged to receive the photodetector outputs. In a pre-processing step, the processor provides a threshold detector operable to convert the (analog) photodetector output signals into a binary digit based on a threshold decision. The processor 60 may be a general purpose microprocessor (μP), a digital signal processor (DSP) or a field programmable gate array (FPGA), for example.

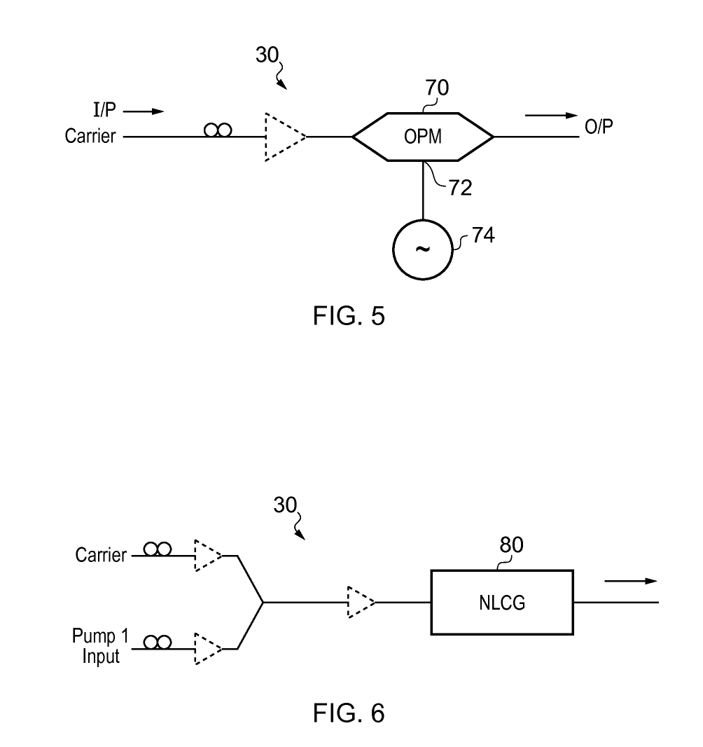

FIG. 5 shows one implementation of the linear optical comb generator 30 of the first embodiment which comprises an optical phase modulator 70 arranged to receive the carrier, free of phase modulation, and having a drive input 72 to receive an electronic clock signal from a high frequency RF clock 74 that acts to phase modulate the carrier in order to generate the linear comb.

FIG. 6 shows another implementation of the linear optical comb generator 30 of the first embodiment which comprises non-linear optical element 80, so is effectively a non-linear comb generator device serving to generate a linear comb by virtue of the absence of any phase modulation in its inputs. Namely, the non-linear optical element 80 is connected to receive the carrier, free of phase modulation, and the first pump, in which the pump and the modulation-free carrier are subject to four-wave mixing to generate the linear comb.

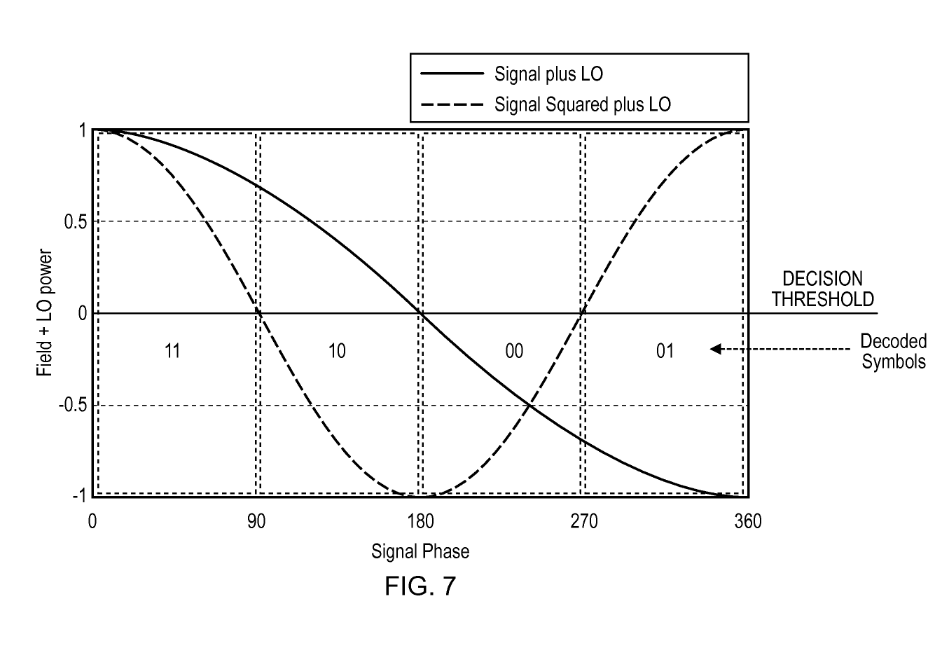

FIG. 7 is a graph showing signal phase against power of the first and second interfered comb components for the 2-bit analog-to-digital conversion scheme of the first embodiment which combines the first and second phase harmonics of the non-linear comb with the corresponding frequency components of the linear comb. The power at the frequency of the first order harmonic component as a function of signal phase is shown by the solid line with zero amplitude at a phase of 180°, and the power at the frequency of the second order harmonic component is shown by the dashed line with zero-crossings at 90° and 270°. This is the scheme that would be used for QPSK which is a four-level or four-state phase encoded signal.

The first and second bits of the 2-bit number representing the four possible levels of the QPSK signal are decoded by setting a decision threshold following photo-electric detection of the interference result for each of the two interfered frequency component pairs. The decision is to output a 1 for a power above the threshold and a 0 for a power below the threshold. The four permutations of thresholding outputs of the two interfered frequency components (first and second order) give all possible values of a 2-bit binary number, i.e. 11, 10, 00 and 01, as illustrated for progressive phase ranges of width 360/4=90°. The QPSK symbols are thus decoded and output without the need for any electronic processing of multi-level, i.e. supra-binary, inputs. The first task carried out in the (electronic) processor is the same task as carried out to process the input from a conventional electronic ADC, namely thresholding of the outputs from the ADC.

While this first example is only of a 2-bit or 4-level signal, the design is scalable to higher bit numbers, so the benefit of the all-optical processing of the multi-level signal becomes ever greater in terms of removing the need for ultra-fast supra-binary electronic processing in a DSP or other processor.

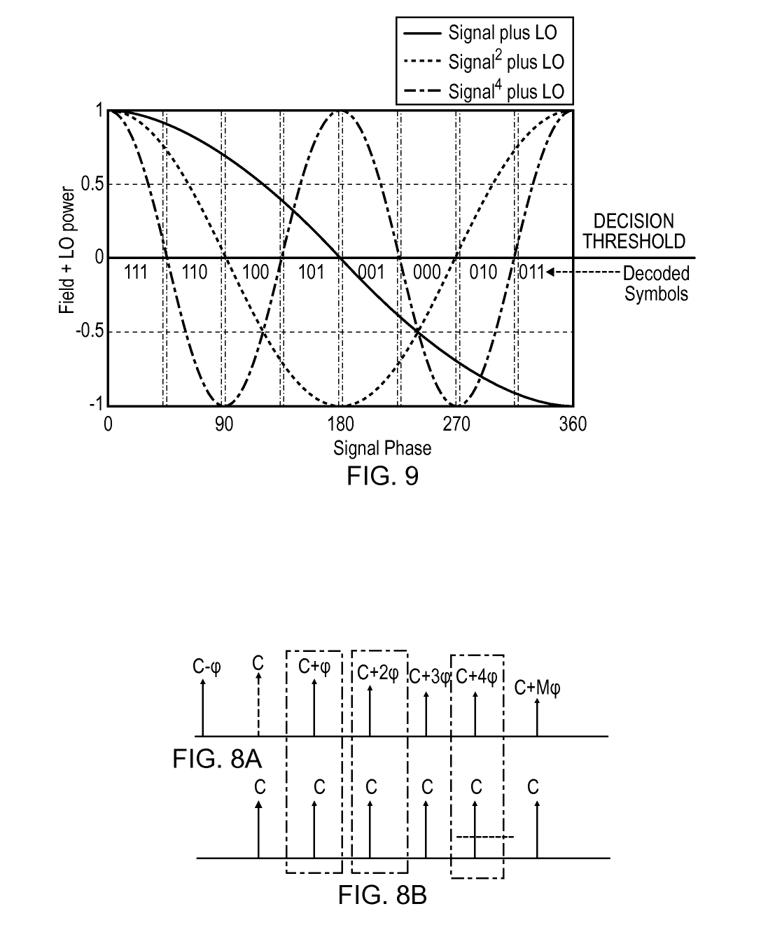

A 3-bit or 8-level example is now described with reference to FIG. 8 and FIG. 9. The same device structure as described with reference to FIG. 3 and subsequent figures is used.

FIG. 8 is similar to FIG. 2, but shows shaded the frequency components relevant for a coherent optical receiver for decoding a 3-bit, i.e. 8-level or state phase shift keyed (8-PSK) signal with FIG. 8(a) showing the frequency products of the non-linear comb and FIG. 8(b) the frequency products of the linear comb. The power at the frequency of the first order harmonic component as a function of signal phase is shown by the solid line with zero amplitude at a phase of 180°; the power at the frequency of the second order harmonic component is shown by the dashed line with zero-crossings at 90° and 270°; and the power at the frequency of the third order harmonic component is shown by the dot-dashed line with zero-crossings at 45°, 135°, 225° and 315°.

FIG. 9 is a graph of the same type as FIG. 7 showing a 3-bit analog-to-digital conversion scheme which combines the first, second and fourth phase harmonics of the non-linear comb with the corresponding frequency components of the linear comb. The 8 permutations of thresholding outputs of the 3 interfered frequency components give all possible values of a 3-bit binary number, i.e. in order of signal phase 111, 110, 100, 101, 001, 000, 010, and 011 as illustrated for progressive phase ranges of width 360/8=45°.

Generally, for M-PSK decoding, a non-linear comb including phase harmonics up to M/2 will be required, e.g. for 8-PSK, the 4th harmonic will be needed.

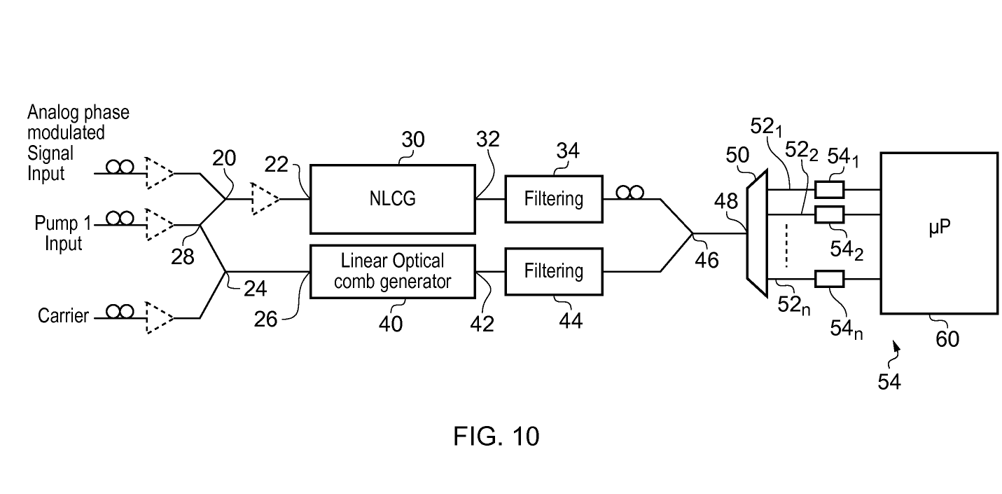

FIG. 10 is a block diagram of an analog-to-digital converter with integrated serial-to-parallel converter according to a second embodiment. In fact, the structure is identical to that of the first embodiment. Consequently, the same reference numerals are used. All of FIGS. 3 to 9 and supporting text are also applicable to the ADC implementation. In the ADC implementation, all that is different is the input signal, which is an analog phase modulated signal, rather than a multi-level phase modulated signal containing encoded binary data. Since the meaning or significance of the input signal differs between the first and second embodiments, so too does that of the output, which in the case of the ADC is the same as a conventional electronic ADC, i.e. a number in n-bit binary format expressing the magnitude of the input signal. Parallel single bit photo-electric detection is thereby achieved.

As will be appreciated, there is demand for higher bit number ADCs, e.g. n=5, 6, 7 or 8 corresponding to a bit resolutions of 32, 64, 128 or 256, although lower bit number ADCs, e.g., n=2 or 3 have applications. Generally, for n-bit quantization, phase harmonics up to order 2ⁿ are required. Moving to higher bit numbers, it will be appreciated that the NLCG as described in relation to FIG. 4 will be problematic, since progressively less power resides in the higher order harmonics. There will therefore be some cut off dictated by performance and noise characteristics of the device which in a practical device will mean that only harmonics up to a certain order are useable. A NLCG design to address this limitation is now described.

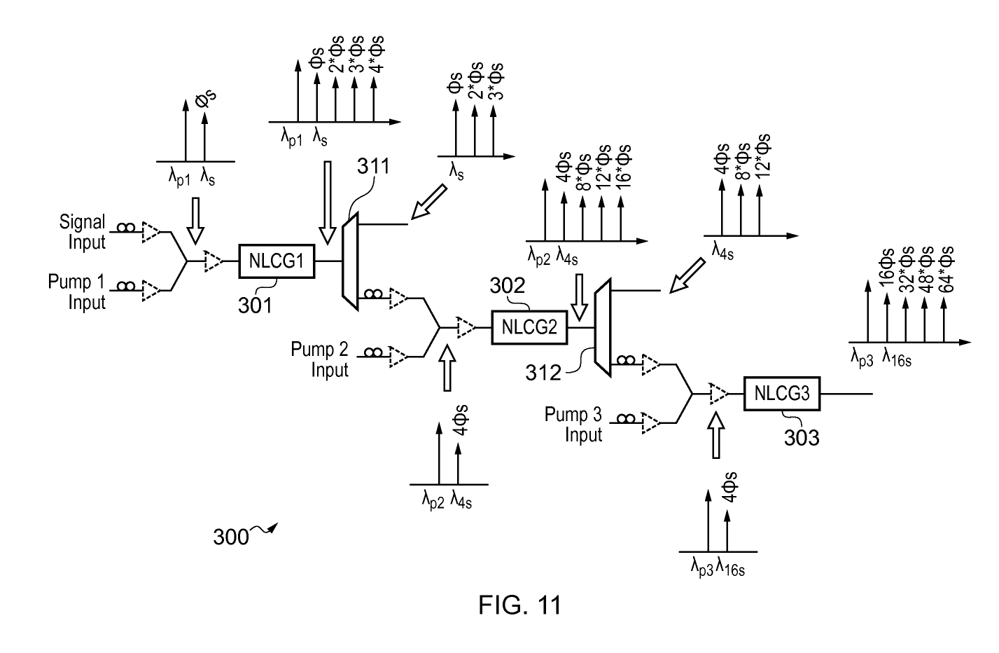

FIG. 11 shows a non-linear comb generator (NLCG) 300 for generating arbitrary numbers of phase harmonics which is particularly suited for use as the comb generator in a higher bit number ADC according to the second embodiment.

The NLCG essentially consists of three cascaded stages of the NLCG of FIG. 4, wherein each stage after the first is pumped by a harmonic component picked out from the preceding stage. Three stages are shown, since this shows all the principles of the cascaded arrangement which can be cascaded in an arbitrary number of stages including 2, 3, 4, 5, 6 or more. Moreover, as well as a linear series, it would be possible to pick off more than one harmonic component from a previous stage as pumps for other stages.

The signal of wavelength λₛ and pump—Pump 1—of wavelength λₚ₁ are combined in a fiber coupler and supplied to an input of a first NLCG 301-NLCG1—which generates a non-linear comb of a series of harmonic components of the signal separated in wavelength (more correctly frequency) by the offset |λₚ−λₛ| so that the Mth order harmonic carries the phase harmonic of exponential i·Mφ as defined further above. The 1st to 4th order harmonic components are illustrated as being generated by NLCG1, these being the four strongest harmonics. The output of NLCG1 is supplied to a wavelength division demultiplexer 311, or other filter, which separates out the 4th order harmonic from the 1st, 2nd and 3rd order harmonics. By filtering (not shown), the 5th and higher order harmonics are eliminated or suppressed.

The 4th order harmonic component generated by four-wave mixing in NLCG1 is thus picked out with a wavelength division demultiplexer. The picked out component is then combined in a coupler with a second pump—Pump 2—having a frequency separation from the picked out component equal to said frequency offset |λₚ−λₛ|. Pump 2 and the 4th harmonic are then supplied to a second NLCG 302-NLCG2—to four-wave mix the 4th harmonic with Pump 2, labeled as wavelengths λₚ₂ and λ₄ₛ respectively, thereby to generate another set of harmonics at integer multiples of the 4th harmonic. The first, second, third and fourth harmonics of NLCG2 are effectively higher-power versions of the fourth, eighth, twelfth and sixteenth harmonics of NLCG1, but conveniently at adjacent frequency positions, since the “intermediate” harmonics, i.e. equivalents of say the 5th, 6th and 7th harmonics of NLCG1 are not produced by NLCG2, so that for example the harmonic with exponential i·4φ is only separated from the exponential i·8φ by one offset |λjₚ−λₛ|. The third stage is constructed in the same fashion as the second stage in that the 16th order harmonic component of wavelength λ₁₆ₛ generated by four-wave mixing in NLCG2 is picked out using an optical wavelength demultiplexer 312 and combined in a coupler with a third pump—Pump 3—of wavelength λₚ₃ where |λₚ₃−λ₁₆ₛ|=|λₚ−λₛ|. Pump 3 and the 16th harmonic are then supplied to a third NLCG 303-NLCG3—to four-wave mix them, thereby to generate another set of harmonics at integer multiples of the 16th harmonic, i.e. at i·16φ, i·32φ, i·48φ and i·64φ. It will be understood that fourth and further stages can be added as desired.

To summarize, the illustrated 3-stage NLCG cascade generates harmonic components of order: 1, 2, 3, 4, 8, 12, 16, 32, 48 and 64. The 3-level NLCG cascade illustrated can thus be used in a 7-bit ADC for example by using the harmonic components of order 1, 2, 4, 8, 16, 32 and 64, wherein the unwanted components 3, 12, 48 can be filtered out, for example with a wavelength division multiplexer. If a 2-stage NLCG was constructed by eliminating the third stage of FIG. 11, then this would be suitable for use in a 5-bit ADC through the harmonic components of order 1, 2, 4, 8 and 16. It will also be understood that the cascaded design would be useful in coherent receiver implementations, e.g. a 2-stage NLCG cascade could be used for processing 16-PSK which is the equivalent of a 5-bit ADC.

The coherent receiver and ADC devices of the first and second embodiments can be modified to process signals in amplitude modulated formats by providing an amplitude to phase conversion as a pre-processing stage. The devices are thus not only applicable to phase modulated signals.

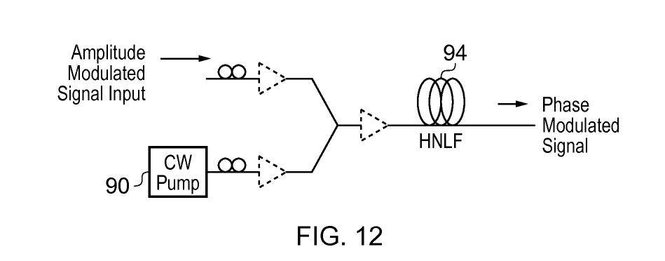

FIG. 12 is a block diagram showing a pre-processing stage which converts amplitude modulation to phase modulation. An amplitude modulated signal is input. A CW pump source 90 provides a pump—Pump 4—which is combined at a coupler 92 with the amplitude modulated signal. The pump P4 and amplitude modulated signal are supplied to a highly non-linear fiber 94 (HNLF) in which the pump and the signal are subject to cross phase modulation to transfer the amplitude modulation on the signal to phase modulation on the pump. A device as described in relation to the first or second embodiments is then arranged to receive the phase modulated signal output from the pre-processing stage.

The coherent receiver and ADC devices of the first and second embodiments can also be modified to process signals in mixed amplitude and phase encoded formats, such as square 16-QAM. This can be achieved by splitting the signal into two and supplying one part of the signal to a device of the first or second embodiments, and the other part of the signal to the above described pre-processing stage to convert the amplitude modulated component to a phase modulated signal component and then supply the output from the pre-processing stage to a further device according to the first or second embodiment.

It may also be possible to extend the optical processing to include the thresholding function described with reference to FIGS. 7 and 9, thereby negating the need for the electronics to perform any analog signal processing.

What is claimed is:

1. A device for processing an optical phase modulated signal borne on a carrier, comprising:
a pump source operable to generate a first modulation-free pump having a frequency offset from the carrier;
an optical non-linear comb generator comprising a section of non-linear optical material arranged to receive the signal and the pump, in which the pump and the signal are subject to four-wave mixing to generate a non-linear comb of a series of harmonic components of the signal separated in frequency by the offset;
an optical linear comb generator arranged to receive the carrier and to generate therefrom linear comb of a series of modulation-free components matched in frequency to the harmonic components generated by the non-linear comb generator;
an optical combiner connected to receive and linearly combine a selection of one or more of the harmonic series components and their corresponding frequency-matched modulation-free components;
an optical wavelength division demultiplexer connected to receive and separate out the linearly combined pairs of harmonic and modulation-free components into a plurality of frequency-specific optical output channels; and
a plurality of photodetectors connected to respective ones of the optical output channels, each photodetector being operable to output an electronic signal representing the intensity of the received linearly combined component pair.

2. The device according to claim 1, wherein the linear comb generator comprises an optical phase modulator arranged to receive the carrier, free of phase modulation, and having a drive input to receive an electronic clock signal that acts to phase modulate the carrier in order to generate the linear comb.

3. The device according to claim 1, wherein the linear comb generator comprises non-linear optical material and is connected to receive the carrier, free of phase modulation, and the first pump, in which the pump and the modulation-free carrier are subject to four-wave mixing to generate the linear comb.

4. The device according to claim 1, further comprising an electronic signal processor having a threshold detector operable to receive the electronic signals from the photodetectors and translate each electronic signal into a binary output based on a threshold decision.

5. The device according to claim 1, wherein the harmonic series of components selected for linear combination and photodetection consists of a plurality of adjacent elements the series 2ⁿ, such as the 1st, 2nd and 4th components or 1st, 2nd, 4th and 8th components.

6. The device according to claim 1, wherein the harmonic series of components selected for linear combination and photodetection consists of the 1st, 2nd and 3rd components.

7. The device according to claim 1, wherein the non-linear comb generator is configured such that one of the harmonic components generated by four-wave mixing in the non-linear optical material is picked out and four-wave mixed with a further pump, in a second four-wave mixing stage, the further pump having a frequency separation from the picked out component equal to said frequency offset or an integer fraction or multiple thereof so as to generate further harmonic components that conform to the comb frequencies and have greater power than equivalent harmonic components at the same frequency generated by the initial four-wave mixing.

8. The device according to claim 7, wherein the non-linear comb generator comprises third and optionally further four-wave mixing stages, each arranged to mix a further pump with a harmonic component picked out from a prior four-wave mixing stage so as to further supplement the comb with higher order components of useable power.

9. The device according to claim 1, further comprising a signal pre-processing stage arranged to receive an optical amplitude modulated signal and convert it to an optical phase modulated signal.

10. The device according to claim 1, further comprising a splitter arranged to receive an optical phase and amplitude modulated signal and separate it into two parts, one of which is supplied as input to the device of claim 1, and the other of which is supplied via a signal pre-processing stage operable to convert the amplitude modulated part of the signal into a phase modulated signal to a further device according to claim 1.

11. The device according to claim 1, wherein the phase modulated signal is a multi-level phase modulated signal containing encoded binary data.

12. The device according to claim 1, wherein the phase modulated signal is an analog phase modulated signal representing a scalar parameter.

13. A method of decoding an optical multi-level phase modulated signal containing encoded binary data comprising supplying the phase modulated signal to the device of claim 1.

14. A method of decoding an optical analog phase modulated signal representing a scalar parameter comprising supplying the phase modulated signal to the device of claim 1.

15. The device according to claim 2, further comprising an electronic signal processor having a threshold detector operable to receive the electronic signals from the photodetectors and translate each electronic signal into a binary output based on a threshold decision.

15. The device according to claim 3, further comprising an electronic signal processor having a threshold detector operable to receive the electronic signals from the photodetectors and translate each electronic signal into a binary output based on a threshold decision.

16. The device according to any of claims 2, wherein the harmonic series of components selected for linear combination and photodetection consists of a plurality of adjacent elements the series 2ⁿ, such as the 1st, 2nd and 4th components or 1st, 2nd, 4th and 8th components.

17. The device according to claim 2, wherein the non-linear comb generator is configured such that one of the harmonic components generated by four-wave mixing in the non-linear optical material is picked out and four-wave mixed with a further pump, in a second four-wave mixing stage, the further pump having a frequency separation from the picked out component equal to said frequency offset or an integer fraction or multiple thereof so as to generate further harmonic components that conform to the comb frequencies and have greater power than equivalent harmonic components at the same frequency generated by the initial four-wave mixing.

18. The device according to claim 2, further comprising a signal pre-processing stage arranged to receive an optical amplitude modulated signal and convert it to an optical phase modulated signal.

19. The device according to claim 2, wherein the phase modulated signal is a multi-level phase modulated signal containing encoded binary data.

20. The device according to claim 2, wherein the phase modulated signal is an analog phase modulated signal representing a scalar parameter.
